(19) United States
(12) Patent Application Publication
(10) Pub. No.: US 2022/0294060 A1
(43) Pub. Date: Sep. 15, 2022

(54) Battery Box with Frame Reinforcing Element

(71) Applicant: Linde + Wiemann SE & Co. KG, Dillenburg (DE)

(72) Inventors: Werner SCHMIDT, Alzenau (DE); Marcel GEORG, Siegen-Geisweid (DE); Christian WAGNER, Heuchelheim (DE); Alex ZEISER-RASUMAK, Marburg-Ockershausen (DE); Hartmut STRAUCH, Steffenberg (DE); Florian SCHMIDT, Giessen (DE); Daniel NIERHOFF, Mühlheim an der Ruhr (DE); Mareike ZIEGENBRUCH, Ratingen (DE); Carl-Christoph FRIEDRICH, Neukirchen-Vluyn (DE); Erik HILFRICH, Düsseldorf (DE)

(73) Assignee: Linde + Wiemann SE & Co. KG, Dillenburg (DE)

(21) Appl. No.: 17/639,370

(22) PCT Filed: Sep. 3, 2020
(86) PCT No.: PCT/EP2020/074555

§ 371 Date: Mar. 1, 2022

(30) Foreign Application Priority Data
Sep. 5, 2019 (DE) 10 2019 123 906.0

(51) Int. Cl. H01M 50/242; H01M 50/249; H01M 50/24; H01M 50/258

(52) U.S. Cl. CPC H01M 50/242; H01M 50/249; H01M 50/24; H01M 50/258

(57) ABSTRACT

The invention relates to a battery box for accommodating at least one battery for an electric vehicle, having an outer circumferential frame and a base. Below the frame, a circumferential frame reinforcing element is arranged for reinforcing the frame, wherein the material thickness of the frame reinforcing element corresponds to its cross-sectional height.

### CROSS-REFERENCE TO RELATED APPLICATIONS

This application is a national stage application (under 35 USC § 371) of PCT/EP2020/074555, filed Sep. 3, 2020, which claims benefit of DE 102019123906.0, filed Sep. 5, 2019, the contents of each of which is incorporated by reference herein.

### BACKGROUND OF THE INVENTION

### Technical Field and State of the Art

The invention relates to a battery box with a frame reinforcement element for an electric vehicle.

Prior-art electric motor vehicles have units that are employed as electric energy storage devices, hereinafter referred to as batteries. These batteries have a modular structure and are often divided into individual, separate cells, hereinafter referred to as battery cells. For example, such battery cells can consist of rechargeable secondary cells, which are usually referred to as accumulators.

Large-scale serial production makes use of battery boxes which hold the individual battery cells. Each individual battery cell is mechanically joined to the battery box in order to prevent it from slipping during operation. The battery box is especially intended for installation into or for mounting onto a motor vehicle, for instance, a passenger car or a truck, especially in the base area. On the one hand, the battery box serves as a modular assembly that simplifies the serial production of a vehicle. On the other hand, the battery box protects the battery cells against environmental influences as well as against damage caused by mechanical effects of the type that could occur, for example, in case of an accident.

For instance, the battery cells can be screwed to the inside of the battery box. This can be done with connecting elements which are called, among other things, screw nodes, screw points, screw bosses or screw blocks, which can be connected to a baseplate of the battery box. The individual battery cells are then screwed together using the connecting elements.

The baseplate of the battery box also serves to seal the underside of the battery box. As a rule, the baseplate is configured so as to be closed and the above-mentioned connecting elements are joined to the inside of the baseplate.

German patent application DE 10 2016 115 037 A1 discloses a battery box of the generic type for motor vehicle batteries. Numerous requirements are made of such battery boxes. For instance, they primarily have to support the weight of the battery elements, that is to say, battery cells that are normally combined into modules. For this purpose, a sort of side wall or frame is generally provided which serves to attach many components of the battery housing itself and also to attach the battery box directly or indirectly to the body of the motor vehicle.

Such battery elements have to be protected against damage in case of an accident or some other damage to the vehicle. In this context, the battery box serves especially as a barrier for crash loads that are exerted from the side and from below. Here, the frame can transmit the crash loads into support structures that are situated inside or below the battery compartment. In case of a side crash, however, the frame should only intrude into the interior of the battery box to the smallest extent possible so as to avoid damage to the battery elements.

German patent application DE 10 2016 115 037 A1 discloses a battery box with lateral reinforcement. This side wall structure has an attachment area that is located further inwards than the outer side walls and that serves to join the side wall structure to the cover.

All in all, the battery box or its frame should take up as little installation space as possible, and the inside of the housing should contain as few internal support structures as possible, which is an objective that is in conflict with the crash requirements.

Before this backdrop, the invention has the objective of creating a battery box for an electric vehicle that has a simple structural design and that, at the same time, exhibits an improved absorption capacity in case of a collision.

### SUMMARY OF THE INVENTION

The invention relates to a battery box for accommodating at least one battery for an electric vehicle, having an externally surrounding frame and a base.

According to the invention, a surrounding frame reinforcement element is arranged underneath the frame in order to reinforce it, wherein the material thickness of the frame reinforcement element corresponds to its cross-sectional height. In other words, at least part of the frame reinforcement element has a full cross section.

The frame reinforcement ensures the distribution of the crash load in order to prevent bulging, particularly of the plate(s) of the housing base.

The frame and the frame reinforcement element are situated in the so-called deformation zone and they absorb crash-induced forces. These forces are distributed inside the frame without transmitting the crash-induced forces to the batteries or accumulators that are surrounded by the frame. Therefore, the batteries are arranged in a largely crash-protected manner inside the motor vehicle, and they can be integrated into existing vehicle production lines or into existing vehicles.

According to a first advantageous embodiment of the invention, it is provided for the base to consist of several base layers arranged at a distance from each other, wherein the frame reinforcement element is arranged inside a base cavity formed by the base layers.

This is a so-called hybrid base battery box or high-voltage storage unit (HVS), wherein the base of the battery box can consist of a cover plate or a baseplate, namely, the base layers. Therefore, the base can consist of several layers in the form of a “sandwich structure”. The battery base rests on an inner base layer, that is to say, when this base layer is in its installed position, it is the upper layer, which is also referred to as the intermediate base. The batteries are arranged on the upper base layer, in other words, on the intermediate base. Arranged underneath at a distance is the outer or lower base layer, the so-called underride guard.

The frame of the battery box can have at least two structural components that are joined together at their ends, and they can have an essentially rectangular cross section. The profile segment can be connected to the car body via fastening means.

According to another advantageous variant of the invention, the material thickness of the frame reinforcement element corresponds to its cross-sectional height, wherein the material thickness at least partially corresponds to the distance of the base layers.

In other words, at least part of the frame reinforcement element has a full cross section over the entire distance of the base layers.

In particular, it can be provided for the cross-sectional width of the full cross section of the frame reinforcement element to be greater than its cross-sectional height.

The term “full cross section” refers to a continuous, that is to say, solidly configured area of the profile component, in other words, a solid material. Owing to this configuration, the horizontal crash load is introduced directly into the multipart housing base.

The lower base layer forms the underride guard while the upper base layer forms an intermediate base. Together, they form the cover layers of a partially hollow base structure. The frame reinforcement keeps the base layer at a distance. The greatest possible reaction force needed in case of a lateral impact is generated primarily by the surrounding frame reinforcement that is the furthest towards the outside in the base structure.

Another advantageous variant of the invention provides for the frame to adjoin at least one base layer and/or for the frame to form a closed profile together with at least one base layer, so that the crash load can be absorbed even more effectively by the battery box.

According to another advantageous embodiment of the invention, the frame reinforcement element is configured at least partially as a hollow profile, preferably as an extruded profile. This ensures that the base structure remains essentially planar and does not bulge or buckle in response to a crash load. Moreover, temperature-control medium channels that run longitudinally and/or optionally crosswise can be accommodated in the profile on the side facing the interior of the battery housing, said channels creating a cavity for conveying the temperature-control media. Aside from the task of providing the best possible crash-protection performance, the component can additionally be used as a distributor for a cooling or heating system in the battery housing.

It can be provided for at least certain areas of the frame reinforcement element to completely fill the base cavity between the base layers in order to better be able to absorb the crash-induced forces.

In an advantageous refinement of the invention, the frame is made by means of extrusion, roll forming or edge profiling.

According to another advantageous embodiment of the invention, the frame covers the end faces of the base. This ensures an effective sealing of the frame, especially with an eye towards attaining better corrosion protection. The frame also creates an attachment to the housing cover. An effective introduction of the crash load is nevertheless ensured.

The externally surrounding frame can be formed by a hollow profile, especially a multi-chamber hollow profile. Preferably, at least one transverse beam and at least one longitudinal beam are arranged in the frame. Accommodating spaces that serve to accommodate the at least one battery are formed by the at least one transverse beam and by the at least one longitudinal beam. The at least one battery is then especially inserted into the accommodating spaces in such a way that it is flat and it is preferably coupled under a pre-tensioning force against the partitions so as to be upright in the accommodating spaces; in particular, screws are used for the coupling. In this manner, the heat generated in each battery can be transmitted via the battery base to the base of the battery box through heat conduction. Consequently, heat is conducted from the battery base to the base of the battery box. It is likewise conceivable for heat to be fed to the battery in order to establish a certain operating temperature.

Furthermore, the frame allows the batteries that are arranged inside the vehicle to be accommodated in a secure position and to be transported safely. The frame can surround the full circumference of the accumulators or can surround them at least partially, and said frame can have first fastening means for fastening the accumulators to the frame as well as second fastening means for fastening the frame to the vehicle parts.

The hollow profile sections of the frame have at least one deformation zone for purposes of at least partially absorbing crash-induced loads. Such a frame surrounds the accumulators that are arranged inside the vehicle and thus largely protects them from crash-induced damage. This is achieved in that the frame, especially the deformation zone, can absorb the crash-induced forces and can distribute them within the frame, so as to minimize the crash-induced forces acting on the accumulators that are surrounded by the frame. Therefore, the accumulators are arranged in a largely crash-protected manner inside the vehicle, and they can be integrated into existing vehicle production lines or into existing vehicles; the frame also serves to reliably secure the accumulators.

The state of the art discloses that the force transmission path runs primarily through the module space of the battery housing. For this reason, the inside of the frame structure could bulge out of or collapse into the installation space of the battery modules. Consequently, the invention prevents damage that would inevitably be associated with this. The hollow profile sections of the frame have at least one deformation zone that serves to at least partially absorb crash-induced loads. Such a frame surrounds the accumulators that are installed inside the vehicle and thus largely protects them from crash-induced damage.

According to a refinement of the invention, the frame of the battery box and at least one base layer are integrally bonded to each other and/or coupled with a positive fit, especially welded. The welding procedure can be laser welding with a continuous seam or an intermittent seam and with a sealed seam, so as to create a sealed interior. At least one base layer, especially the intermediate layer, is welded and optionally glued. The base layer referred to as the underride guard can also be welded and/or glued. Likewise conceivable is a non-positive coupling of the underride guard to the frame, for instance, by means of a screwed connection.

According to another advantageous embodiment of the invention, at least one transverse profile component and/or at least one longitudinal profile component is/are provided in the base cavity between the base layers or on a base layer for purposes of stiffening the frame reinforcement element. These components support the full cross-sectional frame towards the inside.

According to a refinement of the invention, the frame reinforcement element has at least one through-hole and/or at least a one-sided or two-sided indentation. These slightly reduce the crash-protection performance, but have an overwhelmingly positive effect in that they reduce the total weight.

It can be advantageously provided that at least one base layer is made of a metal material; preferably, both base layers are made of a metal material, especially of steel or a steel alloy. Preferably, the base layers can consist of a steel plate, thereby further improving the crash-protection performance or the intrusion resistance of the battery box.

The at least one base layer can have a maximum thickness of about 0.8 mm to 2 mm, preferably 1.5 mm.

It is conceivable for the frame reinforcement element and at least one base layer to be integrally bonded to each other and/or coupled with a positive fit, especially welded and/or glued. In this context, especially inert gas welding, laser welding or resistance welding can be considered.

Moreover, the base layers can be integrally bonded to each other and/or coupled with a positive fit, especially welded, preferably spot welded or laser welded. This translates into a simple production method and into a strong connection of the base layers, resulting in greater shear strength and thus crash safety. For purposes of the spot welding, so-called embossing can be created in the base layer, so that the base layers, which are at a distance from each other, only touch in a few places where they can be joined.

According to another advantageous embodiment of the invention, a temperature-control unit, especially a cooling unit that serves to dissipate the heat of the at least one battery or else a heating unit that serves to feed heat to the battery, is arranged in the base cavity. The temperature-control unit is located on the outer or lower base layer, so that, as a result, the temperature-control unit is situated between the base layers. This accounts for a very good transmission of heat from the battery base to the temperature-control unit via the inner base layer.

In another variant of the invention, the lower base layer projects outwards relative to the upper base layer that faces the batteries. This provides the possibility of creating a simple attachment of the frame of the battery box to the base. After all, fastening means for attachment to the frame can be installed in the sections of the base that project outwards, especially in one or more base layers. As an alternative or in addition, it is conceivable for the frame to be welded onto the sections of the base that project outwards, thereby creating a secure connection between the frame and the base in order to form the battery box, thus further improving the attachment of the base to the frame. The base layer that is facing the battery should be considered as an intermediate base, that is to say, the batteries rest on top of it. The temperature-control unit is situated underneath the upper base layer, and below that is the lower base layer, that is to say, the underride guard. The frame of the battery box can be arranged between the sections of the base layer that project outwards and can be coupled to them, especially welded. This further improves the attachment of the base to the frame.

The frame reinforcement element can have a material thickness of at least 3 mm, preferably 6 mm.

It is likewise conceivable for the frame to have at least one inner reinforcement profile that is arranged inside the frame or the frame profile. If the frame is open on one side or consists of several parts joined together, it is also possible to insert additional interior reinforcements into the frame. This can further improve the crash-protection performance or, alternatively, this can reduce the weight in comparison to a non-reinforced variant, while still providing the same crash-protection performance.

Additional objectives, advantages, features and application possibilities of the present invention ensue from the description below of an embodiment making reference to the drawing. In this context, all of the described and/or depicted features, either on their own or in any meaningful combination, constitute the subject matter of the present invention, also irrespective of their compilation in the claims or the claims to which they refer back.

### DESCRIPTION OF THE DRAWINGS

The following is shown, in part schematically:

FIG. 1 a battery box with a surrounding frame and with a frame reinforcement element,

FIG. 2 detailed view of the base of the battery box with a frame,

FIGS. 3a and 3b detailed views of the base of the battery box with a frame and another embodiment of the frame reinforcement element, where the embodiment of FIG. 3b has a cavity therein for a fluid heat carrier,

FIGS. 4a and 4b detailed views of the base of the battery box with a frame and another embodiment of the frame reinforcement element, where the embodiment of FIG. 4b has a cavity therein for a fluid heat carrier,

FIGS. 5a and 5b detailed views of the base of the battery box with a frame and another embodiment of the frame reinforcement element, where the embodiment of FIG. 5b has a cavity therein for a fluid heat carrier,

FIGS. 6a and 6b detailed views of the base of the battery box with a frame and with another embodiment of the frame reinforcement element, where the embodiment of FIG. 6b has a cavity therein for a fluid heat carrier,

FIGS. 7a and 7b detailed views of the base of the battery box with another embodiment of the frame, where the embodiment of FIG. 7b has a cavity therein for a fluid heat carrier,

FIG. 8 detailed view of the base of the battery box with a frame and with another embodiment of the frame reinforcement element,

FIG. 9 detailed view of the base of the battery box with a frame and with another embodiment of the frame reinforcement element,

FIG. 10 detailed view of the base of the battery box with a frame and having a temperature control unit, and

FIG. 11 detailed view of the base of the battery box with a frame with a single layer base and with another embodiment of the frame reinforcement element.

### DETAILED DESCRIPTION

For the sake of clarity, identical components or those having the same effect are provided with the same reference numerals in the figures of the drawings shown below, making reference to an embodiment.

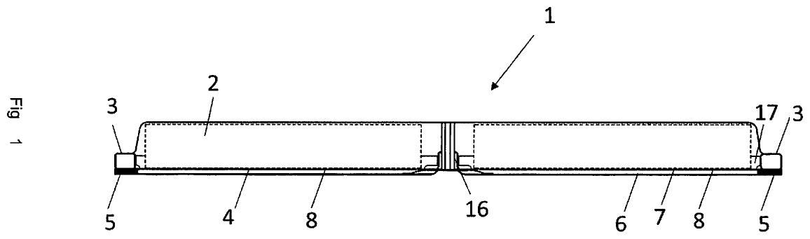

FIG. 1 shows a battery box 1 for accommodating at least one battery 2 for an electric motor vehicle. The battery box 1 can have a cover 9 as shown in FIG. 1.

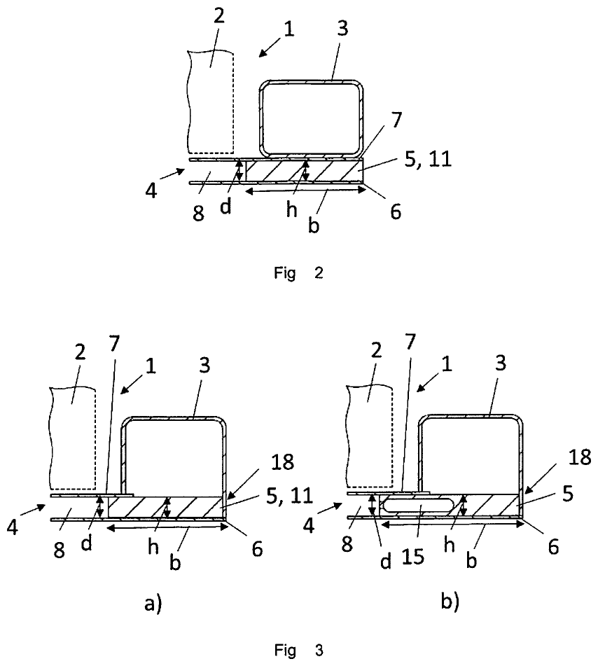

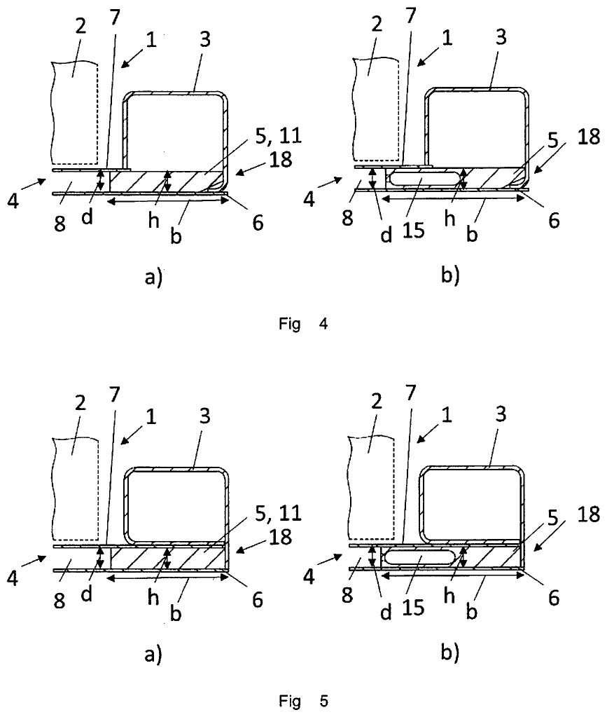

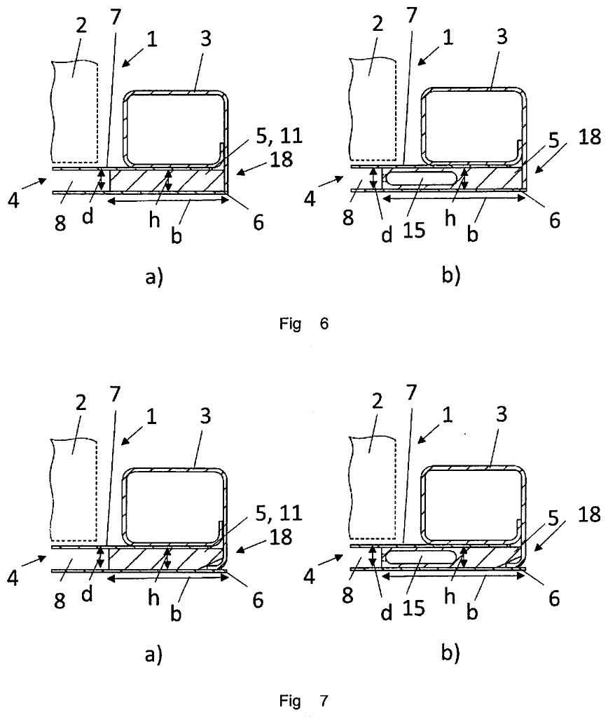

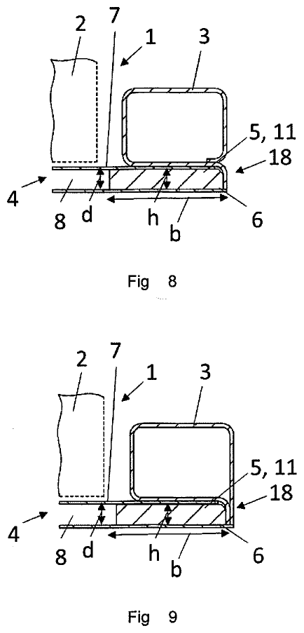

In the embodiments according to FIGS. 2 to 10, the base 4 of the battery box 1 is configured with two layers and has a cover plate or base plate, the so-called base layers 6, 7. FIG. 11 shows an embodiment having a single-layered base 4.

As can also be seen in FIGS. 1 to 11, the battery box 1 has an externally surrounding frame 3. The frame 3 of the battery box 1 can have at least two structural components 16, 17 that are joined to each other at their ends and that have an essentially rectangular cross section. The frame 3 here consists of a hollow profile, especially of a multi-chamber hollow profile. The detailed views depicted in FIGS. 2 to 11 show the frame 3 with at least one transverse beam 16 and at least one longitudinal beam 17. The frame 3 can be connected to the car body by fastening means.

The at least one transverse beam 16 and/or the at least one longitudinal beam 17 form accommodating spaces that serve to accommodate the at least one battery 2, as can be seen in FIG. 1. The at least one battery 2 is especially inserted into the accommodating spaces in such a way that it is flat and preferably coupled under a pre-tensioning force against the beams 16, 17 so as to be upright in the accommodating spaces. Screws are preferably used for the coupling. In this manner, the heat generated in each battery 2 can then be transmitted via the battery base to the base 4 of the battery box 1 through heat conduction. However, it is likewise conceivable for the battery box 1 not to have a transverse beam 16 and/or a longitudinal beam 17, particularly when it comes to relatively small battery boxes 1.

As can also be seen in FIGS. 1 to 11, a surrounding frame reinforcement element 5 is arranged underneath the frame 3 in order to reinforce it. In this context, the material thickness of the frame reinforcement element 5 corresponds to its cross-sectional height h. In other words, at least part of the frame reinforcement element 5 has a full cross section 11.

As mentioned, the embodiment shown in FIG. 11 depicts a base 4 of the battery box 1 that is configured with one layer, that is to say, it only has the lower base layer 6, the so-called underride guard. In contrast, the embodiments shown in FIGS. 1 to 10 depict a double-layered base 4.

In the embodiments with a double-layered base 4, the material thickness of the frame reinforcement element 5 corresponds to its cross-sectional height h and at least partially corresponds to the distance d of the base layers 6, 7. In other words, at least part of the frame reinforcement element 5 has a full cross section 11 over the entire distance d of the base layers 6, 7. In particular, it can be provided for the cross-sectional width b of the full cross section 11 of the frame reinforcement element 5 to be greater than its cross-sectional height h.

The term full cross section 11 refers to a continuous, that is to say, solidly configured area of the profile component 5, in other words, a solid material. Owing to this configuration, the horizontal crash load is introduced directly into the multipart housing base 4. The frame reinforcement 5 ensures a distribution of the crash load in order to prevent bulging of the base layers 6, 7 of the housing base 4.

As can also be seen in FIGS. 1 to 10, the frame reinforcement 5 keeps the base layers 6, 7 at a distance d. The greatest possible reaction force needed in case of a lateral impact is generated primarily by the surrounding frame reinforcement 5 that is the furthest towards the outside in the base structure.

Moreover, FIGS. 1, 5, 6, 7, 10 and 11 show that the frame 3 adjoins at least one base layer 6, 7. As shown in FIGS. 2 to 9 and 11, the frame 3 forms a closed profile together with at least one base layer 6, 7.

The embodiments according to FIGS. 3 to 9 and 11 show that the frame 3 covers the end faces 18 of the base 4. This ensures proper sealing of the base 4, especially with an eye towards attaining better corrosion protection. The frame 3 also creates an attachment to the housing cover 9.

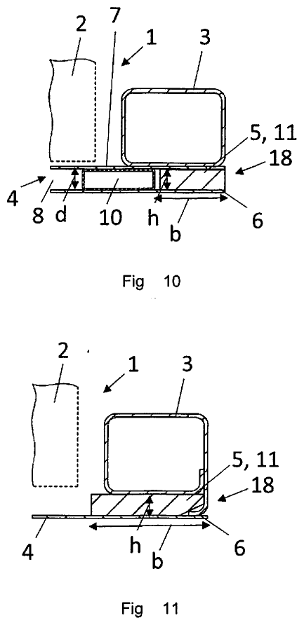

FIG. 10 discloses an embodiment of the battery box 1 with a temperature-control unit 10. In this context, the battery base 7 rests on the inner base layer 7, that is to say, when this base layer 7 is in its installed position, it is the upper layer of the base 4. This base layer 7 is also referred to as the intermediate base. Underneath it, there can be a temperature-control unit 10 that is located on the outer or lower base layer 6, the so-called underride guard, so that consequently, the temperature-control unit 10 is situated between the base layers 6, 7. This accounts for a very good heat transmission of heat from the battery base to the temperature-control unit 10 via the inner base layer 7. This also makes it possible to cool the battery 2 or to keep it at a given operating temperature in that heat is fed to the battery 2.

In the present embodiments, both base layers 6, 7 are made of steel or of a steel alloy, as a result of which the crash-protection performance or the intrusion resistance of the battery box 1 is further enhanced. In particular, the base layers 6, 7 can be made of a steel plate metal and they can be welded together, preferably by means of spot welding or laser welding. For purposes of the spot welding, so-called embossing can be created in the base layer, so that the base layers, which are at a certain distance from each other, only touch in a few places where they can be joined. The at least one base layer 6, 7 can have a maximum thickness of about 0.8 mm to 2 mm, preferably 1.5 mm.

In order to attain a better attachment of the frame 3 to the base 4, a base layer 6, 7 can project outwards relative to the other base layer 6, 7 so that the frame can be easily joined to the projecting section of the base layer 6, 7. In particular, it is likewise conceivable for the lower base layer 6 to project outwards relative to the upper base layer 7 that faces the batteries 2, as is depicted in the embodiments shown in FIGS. 3, 4, 6, 7 and 9. After all, fastening means for attachment to the frame 3 of the battery box 1 can be installed in the sections of the base 4 that project outwards, specially in one or more base layers 6, 7. As an alternative or in addition, it is conceivable for the frame 3 to be welded onto the sections of the base 4 that project outwards.

The frame 3 of the battery box 1 and at least one base layer 6, 7 are integrally bonded to each other and/or coupled with a positive fit, especially welded. The welding procedure can be laser welding with a continuous seam or an intermittent seam and with a sealed seam so as to create a sealed interior. At least one base layer 6, 7, especially the intermediate layer 7, is welded and optionally glued. The base layer 6 referred to as the underride guard 6 can also be welded and/or glued. Likewise conceivable is a non-positive coupling of the underride guard 6 to the frame 3, for instance, by means of a screwed connection.

According to FIG. 1, at least one transverse beam and/or at least one longitudinal beam is/are arranged in the base cavity 8 between the base layers 6, 7 or on a base layer 6, 7 for purposes of stiffening the frame reinforcement element 5. The components support the frame reinforcement element 5, in other words, the full cross-sectional frame towards the inside.

The embodiments as shown in FIGS. 2b, 3b, 4b, 5b and 6b differ from those as shown in FIGS. 2a, 3a, 4a, 5a and 6a in that at least one cavity 15 that is oriented in the profile lengthwise direction is provided to carry a fluid heat carrier.

The appertaining embodiments as shown in FIGS. 1 to 11 differ in terms of the configurations of the base 4, especially of the frame 3 and of the base layers 6, 7 of the battery box 1.

According to FIG. 10, the temperature-control unit 10 is arranged further inside the frame 3 relative to the frame reinforcement element 5. In this manner, the crash-protection means and the liquid conveyance are situated separately from each other in the battery box 1, that is to say, the frame reinforcement 5 is situated in the outer area of the frame 3 whereas the cooling line distribution, which is preferably configured with a rectangular profile, is situated further inwards.

The frame reinforcement element 5 and at least one base layer 6, 7 can be integrally bonded to each other and/or coupled with a positive fit, especially welded and/or glued. In this context, especially inert gas welding, laser welding or resistance welding can be considered.

Moreover, it is conceivable for the frame 3 to have at least one inner reinforcement profile that is arranged inside the frame 3. This profile can be inserted into a frame 3 that is open on one side or that consists of several parts joined together, so that this can further improve the crash-protection performance or, alternatively, this can reduce the weight in comparison to a non-reinforced variant, while still providing the same crash-protection performance.

According to an embodiment of the battery box 1 not shown here, it is conceivable for at least one through-hole and/or at least a one-sided or two-sided indentation to be provided in the Z-direction, wherein these have an overwhelmingly positive effect in that they reduce the total weight.

According to an embodiment not shown here, at least one battery 2 can rest under a pre-tensioning force in such a way that it rests flat on the base 4, especially on the upper base layer 7.

It can also be provided for the base layers 6, 7 to have different plate thicknesses, so that the heat transfer to the temperature-controlled area unit, that is to say, to the batteries 2, can be improved, for instance, by reducing the thickness of the plate at the top.

### LIST OF REFERENCE NUMERALS

1 battery box
2 battery
3 frame
4 base
5 frame reinforcement element
6 base layer
7 base layer
8 base cavity
9 cover
10 temperature-control unit
11 full cross section
14 embossing
15 cavity
16 transverse beam—frame
17 longitudinal beam—frame
18 end faces of the base
d distance
b cross-sectional width
h cross-sectional height

1. A battery box (1) for accommodating at least one battery (2) for an electric vehicle, comprising:
an externally surrounding frame (3) and a base (4), a surrounding frame reinforcement element (5) having a cross-sectional height (h) that is arranged underneath the frame (3) in order to reinforce the frame, wherein material thickness of the frame reinforcement element (5) corresponds to the cross-sectional height (h).

2. The battery box (1) according to claim 1, the base (4) more than one base layer (6, 7), with each base layer arranged at a distance from each other to form a base cavity (8) therebetween, wherein the frame reinforcement element (5) is arranged inside the base cavity (8).

3. The battery box (1) according to claim 2, wherein the material thickness of the frame reinforcement element (5) at least partially corresponds to separation distance between the base layers (6, 7).

4. The battery box (1) according to claim 1, wherein the base of the battery (2) establishes a plane and the frame reinforcement element (5) is arranged in a second plane underneath the plane of the base of the battery (2).

5. The battery box (1) according to claim 2, wherein the frame (3) adjoins at least one base layer (6, 7) or forms a closed profile together with at least one base layer (6, 7).

6. The battery box (1) according to claim 1, wherein the frame reinforcement element (5) is configured at least partially as a hollow profile.

7. The battery box (1) according to claim 2, wherein at least certain areas of the frame reinforcement element (5) completely fill the base cavity (8) between the base layers (6, 7).

8. The battery box (1) according to claim 1, wherein the frame (3) is made by a material shaping method selected from the group consisting: extrusion, roll forming and edge profiling.

9. The battery box (1) according to claim 1, wherein the base (4) defines end faces (18) and the frame (3) covers the end faces (18) of the base (4).

10. The battery box (1) according to claim 1, wherein the frame (3) of the battery box (1) is formed by a hollow profile.

11. The battery box (1) according to claim 10, wherein at least one transverse beam (16) and at least one longitudinal beam (17) are arranged in the frame (3).

12. The battery box (1) according to claim 2, further comprising at least one transverse profile component and/or at least one longitudinal profile component in the base cavity (8) between the base layers (6, 7) or on a base layer (6, 7) configured to stiffen the frame reinforcement element (5).

13. The battery box (1) according to claim 1, wherein the frame reinforcement element (5) defines at least one through-hole and/or at least a one-sided or two-sided indentation.

14. The battery box (1) according to claim 2, wherein at least one base layer (6, 7) is made of a metal material.

15. The battery box (1) according to claim 2, wherein at least one base layer (6, 7) has a maximum thickness of about 0.8 mm to 2 mm.

16. The battery box (1) according to claim 2, wherein the frame reinforcement element (5) and at least one base layer (6, 7) are integrally bonded to each other and/or are coupled together with a positive fit.

17. The battery box (1) according to claim 2, wherein the frame (3) of the battery box (1) and at least one base layer (6, 7) are integrally bonded to each other and/or are coupled together with a positive fit.

18. The battery box (1) according to claim 2, wherein the base layers (6, 7) are integrally bonded to each other and/or are coupled together with a positive fit.

19. The battery box (1) according to claim 1, further comprising one of either a cooling unit to dissipate heat generated by the at least one battery (2), or a heating unit to feed heat to the battery (2) is arranged in the base cavity (8).

20. The battery box (1) according to claim 2, wherein one of the base layers is a lower base layer (6) and another of the base layers is an upper base layer (7), and wherein the lower base layer (6) projects outwards relative to the upper base layer (7) that faces the batteries (2).

21. The battery box (1) according to claim 1 wherein the frame reinforcement element (5) has a material thickness of at least 3 mm.

22. The battery box (1) according to claim 1, wherein the frame (3) has at least one inner reinforcement profile that is arranged inside the frame (3).
